(19) United States
(12) Patent Application Publication
(10) Pub. No.: US 2004/0227110 A1
(43) Pub. Date: Nov. 18, 2004

(54) Procedure and sensor device for detecting an object

(76) Inventors: Wolfgang Eberhard Luxem, Kiel (DE); Thomas Zelenka, Monkeberg (DE)

Correspondence Address: Lawrence P. Kessler, Patent Department, NexPress Solutions LLC, 1447 St. Paul Street, Rochester, NY, 14653-7103, US

(21) Appl. No.: 10/795,903

(22) Filed: Mar. 8, 2004

(30) Foreign Application Priority Data
Mar. 22, 2003 (DE) 103 12 872.7

(51) Int. Cl. G02B 21/06; G01N 21/86

(52) U.S. Cl. 250/559.12

(57) ABSTRACT

Detecting an object, where a light source and an optical receiver are used, and the object is detected by having it intersect the ray of light between the light source and the optical receiver. The optical receiver includes, at least, a fluorescing device.

### FIELD OF THE INVENTION

This invention relates to detecting an object in a path between a light source and a receiver where the receiver includes a fluorescing device.

### BACKGROUND OF THE INVENTION

It is well known to use a multiplicity of sensors for the automatic recognition of objects. Examples of object recognition devices are optical sensors, which have light sources and position-sensitive receiver elements. Examples of these receiver elements are position-dependent sensors, also called position-sensing devices, diode cells, diode arrays, charge-coupled-device (CCD) cells, or arrays. Along with these sensors with two- or three-dimensional receiver elements, measuring systems exist in which individual receiver diodes or individual optical wave-guides are placed next to each other. From the intensity of the individual receivers, conclusions can be drawn about the position of the objects to be detected. Such arrangements can also determine the size of an object. For this, it is necessary to determine the front and rear edges of the object. One thing all of these sensors have in common is that they contain receiver elements that are quite complex and consequently expensive. To obtain a good locational resolution, parallel irradiation over the entire surface of the receiver elements is required. It is these requirements that cause the receiver element to be expensive, which includes costs in development and manufacturing. Due to the necessary interplay of the sensor's complex transmitter with the sensor's expensive receiver, such sensors have only limited reliability and require expensive quality control during manufacture.

### SUMMARY OF THE INVENTION

One goal of the invention, therefore, is to detect an object in simple fashion. Accordingly, there is herein provided a procedure for detecting an object, whereby with a light source and an optical receiver, the object is detected by having it intersect the ray of light between the light source and the optical receiver. The optical receiver includes, at least, a fluorescing device. Due to the fluorescing device, the optical receiver can be configured with a simple structure. The ray of light received can be received independent of location, i.e., the optical receiver does not have to be directed to the ray of light.

It is beneficial for the fluorescing device to guide the received light ray to a light detector in the optical receiver. The detector is simple in the way it detects whether the fluorescing device receives light rays from the light source. In one embodiment of the invention, the ray of light is guided from the light source to a tilting mirror, which reflects the ray of light at a controlled tilt angle in the direction of the fluorescing device. The object is detected in that the tilting mirror reflects the ray of light at various tilt angles in the direction of the optical receiver, and that tilt angle of the tilting mirror is determined at which the object is found between the light source and the optical receiver. By this means, the position of the object is determined.

In a special embodiment form of the invention, the tilting motion of the tilting mirror is assigned a time, so that each tilt angle of the tilting mirror time is assigned a time in unambiguous fashion. The turning angle is determined with the aid of the time, and the tilt angle is related to the position of one of the object's edges. In a beneficial manner, a time is allotted to each tilt angle of the tilting mirror, the tilt angle is measured directly, and the tilt angle is allotted to the position of one of the object's edges. In yet another embodiment form, a time is assigned to each tilt angle of the tilting mirror. The tilt angle is measured with the aid of the steering voltage, and the tilt angle is related to the position of one of the object's edges.

In one particular embodiment form, the fluorescing device is configured as a fluorescing rod. Due to this simple configuration as a rod, a simple arrangement is formed. If the light source is configured as a laser diode, a ray of light is used that has a small diameter, thus making possible sensitive measurements of the object. In another embodiment form, the tilting mirror contains a micro-mirror, thus making possible sensitive measurements of the object.

### BRIEF DESCRIPTION OF THE DRAWINGS

In what follows, embodiment forms of the invention are described in detail with the aid of illustrations in which:

FIG. 1 is a schematic block-diagram depiction of an embodiment form of the invention with a light source 1, a tilting mirror, an optical receiver, which includes a fluorescing device, and an object to be detected between the tilting mirror and the optical receiver;

FIG. 2 is a depiction similar to FIG. 1 in which the tilting mirror is rotated by a certain tilt angle around its axis in the image plane, and the ray of light from the tilting mirror detects the object; and

FIG. 3 shows an embodiment form similar to FIGS. 1 and 2, in which a guidance device is provided that controls a pulse emitter for controlled swiveling of the tilting mirror.

### DETAILED DESCRIPTION OF THE INVENTION

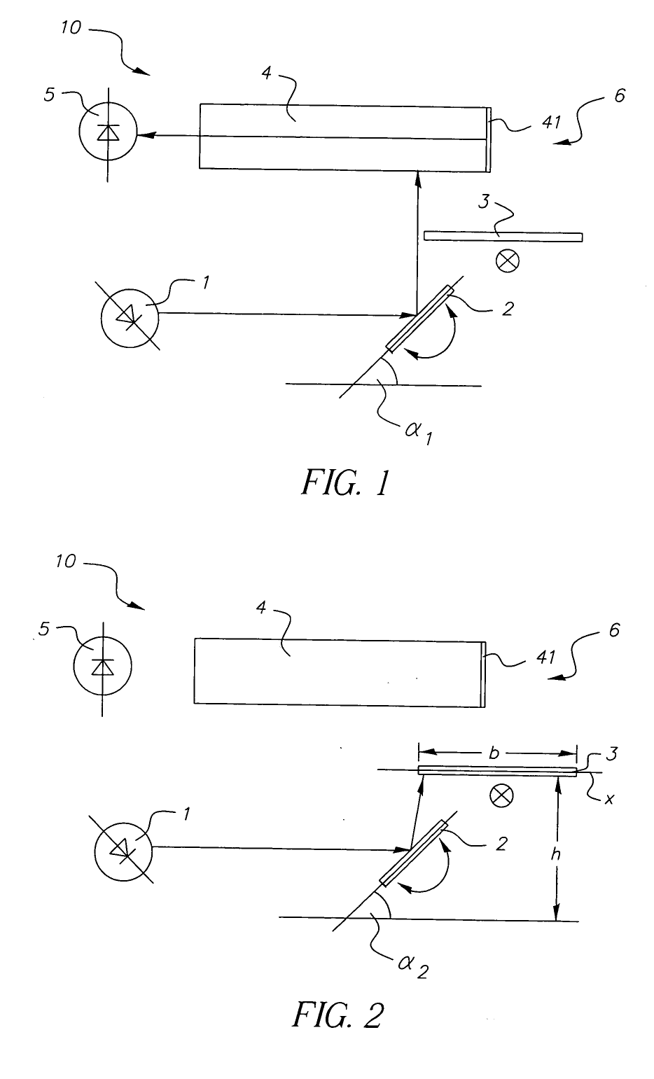

FIG. 1 is a schematic block-diagram depiction of an embodiment form of the invention with a sensor device 10 including a light source 1 which is here configured as a laser diode. Light source 1 makes available a directed beam of light, which radiates in the direction of a tilting mirror 2. Tilting mirror 2 is configured as a micro-mirror, and can be swiveled around its axis in the image plane, as is depicted by the double-ended arrow. Tilting mirror 2 is driven by a motor to change its tilt angle.

The ray of light of light source 1 impinges on tilting mirror 2 and is reflected by it. The ray of light is reflected by tilting mirror 2 in the direction of a fluorescing device 4, here configured as a fluorescing rod. Fluorescing device 4 is detected by an optical receiver 6, and on at least one side, it has a mirror coating 41. An object 3 is placed between tilting mirror 2 and fluorescing device 4, which is detected by the sensor device 10. An optical detector 5 is placed adjacent to fluorescing device 4, which receives the ray of light of fluorescing device 4. The ray of light is received at any point on fluorescing device 4. A part of the ray is reflected from fluorescing device 4 and mirror coating 41 in the direction of optical detector 5, which detects the beam of light. The beam of light from fluorescing device 4 to optical detector 5 is schematically depicted by an arrow.

Optical detector 5 is usually configured as an electro-optic receiver, and, at least, includes a photodiode, whereby an electrical signal is generated from the incident light. In FIG. 1, tilting mirror 2 is at an angle of α₁ and the ray of light is reflected upward from light source 1 on tilting mirror 2 at an angle of 90°. In the vicinity of the ray path of the light reflected from tilting mirror 2, object 3 is moved into the image plane in the direction of the arrow. Object 3 is usually transported by a moving belt, or conveyed in contactless fashion, such as on an air cushion. Object 3 is, for example, a sheet of paper, which is fed through a printing machine. At the alignment of the angle of tilting mirror 2 with the present angle α₁, the ray of light reflected on tilting mirror 2 does not touch object 3, but instead directly impinges on fluorescing device 4. The impinging light is detected by optical detector 5, and converted into electrical current. In this way, at optical detector 5, information is available to the effect that no object 3 is located between tilting mirror 2 and fluorescing device 4.

FIG. 2 is a schematic block-diagram depiction similar to FIG. 1, with a light source 1, a tilting mirror 2, a fluorescing device 4, and an optical receiver 6. Between tilting mirror 2 and fluorescing device 4, an object 3 moves into the image plane. Tilt mirror 2 is swiveled in a controlled fashion around its axis in FIG. 2 in the image plane. The term controlled swiveling is that the tilt angle of tilt mirror 2 is adjustable and, in particular, is known at every time. The placement of tilting mirror 2 now is at an angle of α₂, which is not equal to α₁. The ray of light incident onto tilting mirror 2 is now reflected at a different angle from tilting mirror 2. Object 3 moves in FIG. 2 in the same place as in FIG. 1.

In contrast to FIG. 1, the ray of light reflected from tilt mirror 2 now impinges on object 3, at which the ray of light essentially is reflected, so that, in essence, no light impinges on fluorescing device 4. In contrast to the angular setting of tilting mirror 2, according to FIG. 1, optical detector 5 receives no light from fluorescing device 4. The optical detector gets information that is different than indicated in FIG. 1. In this way, it can be detected whether an object 3 is located between tilting mirror 2 and fluorescing device 4. The location of object 3 can be determined from the angular position of tilting mirror 2. An angular position of tilting mirror 2 can be assigned in unambiguous fashion to a position in the plane x, in which the object is located. For this, we must know at what height h object 3 is located, whereby with geometric calculations, the position of object 3 can be determined.

The edge of object 3 can be determined, in particular. Tilting mirror 2 is swiveled in a controlled fashion. Optical detector 5 receives a signal from fluorescing device 4, as long as a ray of light reflected from tilting mirror 2 is not incident on object 3. As soon as the ray of light of light source 1, reflected from tilting mirror 2, becomes incident on object 3 at a certain angle of tilting mirror 2, optical detector 5 essentially receives no radiation from fluorescing device 4. The edge of object 3 is found in this transition from receiving a light signal to receiving no light signal. If optical detector 5 receives no ray of light, the tilt angle of tilting mirror 2 is determined, and is assigned to a position at the edge of object 3 in plane x. If object 3 is moved out of the area between tilting mirror 2 and optical receiver 6, tilting mirror 2's ray of light is incident on fluorescing device 4, and optical detector 5 receives a signal. The length of object 3 in the image plane direction is determined from the speed at which object 3 moves in the image plane direction, and a time measurement. Both edges of object 3 are detected, and the time between detection of the edges is determined, thus allowing simple determination of the length of object 3. It is preferable, in determining the length of object 3, to maintain the angular position of tilting mirror 2, so that object 3 blocks the ray of light until the rear edge of object 3 is reached in regard to the image plane direction, and behind it the ray of light is freely incident on fluorescing device 4.

Additionally, tilting mirror 2 may be further swiveled so that the ray of light sweeps along object 3, until the beam of light reaches the opposite edge of object 3. This angular position of tilting mirror 2 is determined, and is assigned to a position of object 3. From the position of the two edges of object 3 in the direction of image plane x, its width b may be determined.

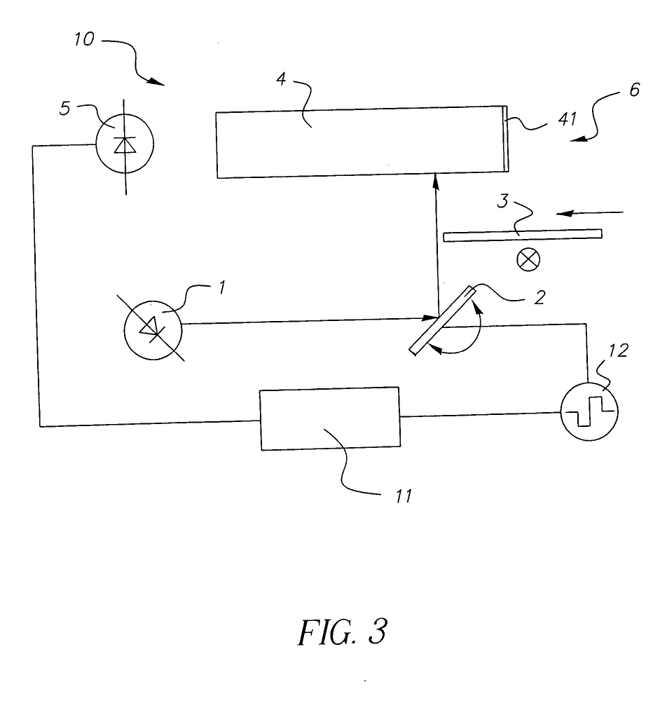

FIG. 3 is a schematic block-diagram view of an embodiment form of the invention with a control device 11, which is connected to optical detector 5 and to a timing device 12. Timing device 12 delivers a time pulse, by a suitable quartz crystal oscillator, for example. Timing device 12 provides time determinations, thereby, with the aid of the speed of object 3, being able to determine the width b and the length of object 3 in the direction of transport. Additionally, in a special embodiment form of the invention, the ability of timing device 12 to make time determinations can contribute to a determination of the angular position of tilting mirror 2, in that tilting mirror 2 is tilted in a uniform motion. The rate, and thus the time, is determined at which a change in signal appears at optical detector 5, i.e., the optical detector either stops receiving a signal when object 3 is interposed, or again starts receiving a signal from fluorescing device 4 when object 3 is removed. The pulse number delivered from timing device 12 to control device 11 is converted into a time. This can be assigned to an angular position of tilting mirror 2, so that in this configuration the angular position of tilting mirror 2 is not measured directly, but rather by the time determined by timing device 12. In this case, timing device 12 counts off a pulse until the change in signal at optical detector 5, with the pulse assigned to an angular position of tilting mirror 2 or directly to a position of object 3.

In a special case, the ray of light of light source 1 is polarized, for example, by linear polarization of the light. The ray of light is irradiated at an acute angle from tilting mirror 2 to object 3. What is thereby attained is, that a transparent object 3 is detected by optical receiver 6. The possibilities of detecting transparent object 3 can be improved by having the polarized light from light source 1 circularly polarized in addition, for example, by a λ/4 lamina, which is situated before transparent object 3 to be detected. The embodiment forms of the invention presented are of particular utility in the detection of side edges of print materials in printing devices. Positional deviations of the print material, for example, can thus be detected, and subsequently corrected.

The invention has been described in detail with particular reference to certain preferred embodiments thereof, but it will be understood that variations and modifications can be effected within the spirit and scope of the invention.

What is claimed is:

1. Procedure for detecting an object (3), comprising the steps of: directing a ray of light from a source (1) generally toward an optical receiver (6) guiding the fluoresced ray of light received to an optical detector (5) of optical receiver (6), and moving an object (3) to intersect the path of light between light source (1) and optical receiver (6), and block the light path.

2. Procedure according to claim 1 further including the steps of guiding the ray of light from light source (1) to a tilting mirror (2), reflecting the ray of light from the mirror (2) at controlled tilt angles in the direction of fluorescing optical receiver (6), detecting the object (3) in that tilting mirror (2) reflects the ray of light at various tilt angles in the direction of optical receiver (6), that the tilt angle of tilting mirror (2) is determined, at which object (3) is between light source (1) and optical receiver (6), and thereby the position of object (3) is determined.

3. Procedure according to claim 2, wherein the motion of tilting mirror (2) is assigned to a time, so that each tilt angle can be assigned in an unambiguous manner to a time, the tilt angle is determined using the time, and the tilt angle is assigned to a position of the edge of object (3).

4. Procedure according to claim 3, wherein a time is assigned to each tilt angle of tilting mirror (2), the tilt angle is measured by the guiding voltage of the drive of tilt mirror (2), and the tilt angle is allocated to the position of one edge of object (3).

5. Procedure according to claim 4, wherein the ray of light is polarized and is incident on object (3) at an acute angle, so that a transparent object (3) is detected by optical receiver (6).

6. Sensor device (10) for detecting an object (3) comprising: a light source (1) for emitting a ray of light, and an optical receiver (6) for receiving the emitted ray of light said optical receiver (6) includes, at least, a fluorescing device (4) for fluorescing the received emitted ray of light, whereby an object (3) between light source (1) and optical receiver (6).

7. Sensor device (10) according to claim 6, wherein said fluorescing device (4) is a fluorescing rod.

8. Sensor device (10) according to claim 6, wherein said sensor device (10) includes a tilting mirror (2) for controlled reflection of the ray of light from light source (1), and a control device (11) for detecting the tilt angle of tilting mirror (2) and assignment of the tilt angle to a position of object (3).

9. Sensor device (10) according to claim 8, wherein said control device (11) includes a chronometer for assignment of a measured time to a tilt angle of tilting mirror (2).

10. Sensor device (10) according to claim 6, wherein said light source (1) includes a laser diode.

11. Sensor device (10) according to claim 6, wherein said light source (1) includes a luminescence diode.

12. Sensor device (10) according to claim 6, wherein said tilting mirror (2) contains a micro-mirror.
